(19) United States
(12) Patent Application Publication
(10) Pub. No.: US 2003/0205308 A1
(43) Pub. Date: Nov. 6, 2003

(54) Tire containing a tube

(75) Inventor: Toshio Yamagiwa, Saitama (JP)

Correspondence Address: BIRCH STEWART KOLASCH & BIRCH, PO BOX 747, FALLS CHURCH, VA, 22040-0747, US

(73) Assignee: HONDA GIKEN KOGYO KABUSHIKI KAISHA, Tokyo (JP)

(21) Appl. No.: 10/462,718

(22) Filed: Jun. 17, 2003

Related U.S. Application Data
(63) Continuation-in-part of application No. 09/697,318, filed on Oct. 27, 2000, now abandoned.
Application No. 09/697,318 is a continuation-in-part of application No. 09/154,777, filed on Sep. 17, 1998, now abandoned.
Application No. 09/154,777 is a division of application No. 08/646,514, filed on May 7, 1996, now abandoned.

(30) Foreign Application Priority Data
May 17, 1995 (JP) HEI-7-118333

(51) Int. Cl. B60C 19/12; B60C 5/02

(52) U.S. Cl. 152/506; 152/507; 152/511

(57) ABSTRACT

A tire containing a tube capable of utilizing a sealant for automatically repairing a damaged portion of a tube pierced with a nail or the like in the radial or the transverse direction and for preventing an air valve, pressure gauge or the like form being blocked with the sealant. Right and left side walls and an outer peripheral wall of the tube contained within the tire are composed of an enclosed bag-like portion. Sealant is sealed in the bag-like portion.

### CROSS REFERENCE TO RELATED APPLICATIONS

This application is a continuation-in-part of application Ser. No. 09/697,318 filed Oct. 27, 2000 which in turn is a continuation-in-part of application Ser. No. 09/154,777 filed on Sep. 17, 1998, now abandoned, which is a divisional application of application Ser. No. 08/646,514 filed on May 7, 1996, now abandoned, the entire contents of each of which are hereby incorporated by reference.

This application claims priority under 35 USC 119 based on application HEI-7-118,333 filed in Japan on May 17, 1995, the entire contents of which is hereby incorporated by reference.

### BACKGROUND OF THE INVENTION

1. Field of the Invention

The present invention relates to a tire containing a tube wherein the tire and the tube form an annular air chamber contained within the tire.

2. Description of Background Art

A tire containing a tube makes use of the excellent air tightness of the tube for providing an inflated tire. The tire is adapted to be mounted on a wheel provided with wire spoke. Such a wheel is extensively used for motorcycles or bicycles.

However, prior art tires containing a tube are inconvenient in that when a tube is pierced with a nail or the like, air in the tube leaks from the damaged portion through a nipple of a rim by way of a fine gap formed between the tire and the tube. Consequently, the tire tends to be punctured.

A method has been known for coping with the above inconvenience, wherein a suitable amount of liquid sealant is injected into a tube. When the tube is pierced with a nail or the like, the liquid sealant automatically acts to provide an emergency repair by covering the damaged portion.

The above-described method, however, has a disadvantage in that the sealant tends to block an air valve of the tube or to block a pressure gauge upon measurement of air in the tube.

### SUMMARY AND OBJECTS OF THE INVENTION

An object of the present invention is to provide a tire containing a tube which is capable of attaining an emergency repair function without causing the above-described problems of the prior art.

To achieve the above object, according to a first aspect of the present invention, at least an outer peripheral wall of the tube is composed of an enclosed bag like portion, and a liquid sealant is sealed in the bag like portion.

According to a second aspect of the present invention, right and left side walls and an outer peripheral wall of the tube are composed of an enclosed bag like portion, and a liquid sealant is sealed in the bag like portion.

According to a third aspect of the present invention, in addition to the feature of the first or second aspect, the annular bag body is disposed to surround the tube main body and is adhesively bonded on an outer surface of the tube main body, to form the bag like portion.

According to a fourth aspect of the present invention, at least an outer peripheral wall of the tube is adhesively bonded on the inner surface of the tire over the entire circumference of the tube.

According to a fifth aspect of the present invention, at least right and left side walls of the tube are adhesively bonded on the inner surface of the tire over the entire circumference of the tube.

According to the first aspect of the present invention, at least the outer peripheral wall of the tube is composed of the bag like portion in which a liquid sealant is sealed. Even when the tube is pierced with a nail or the like through a tread portion of the tire, the sealant acts for emergency repair by covering the damaged portion. The sealant is also held in the bag like portion, and thereby it does not block an air valve or a pressure gauge of the tube at all.

According to the second aspect of the present invention, the right and left side walls and the outer peripheral wall of the tube are composed of the bag like portion in which a liquid sealant is sealed and are held in a shape corresponding to that of the inner surface of the tire by the effect of air pressure in the tube. As a result, the sealant is prevented from being locally shifted by a centrifugal force. Even when the tube is pierced with a nail or the like in the radial direction or in the transverse direction, the sealant acts as an emergency repair by covering the damaged portion of the tube. Like the first aspect, the sealant sealed in the bag like portion does not block an air valve or a pressure gauge of the tube at all.

According to the third aspect of the present invention, the bag like portion which is excellent in air tightness can be easily formed only by adhesively bonding the annular bag body on the outer surface of the tube main body.

According to the fourth aspect of the present invention, when the outer peripheral wall of the tube is pierced with a nail or the like through a tread portion of the tire, the damaged portion of the tire is repaired by contractible elasticity of the tire itself, and air leaking from the damaged portion of the tube is prevented from being diffused to the surroundings from the contact surface between the tire and the tube. As a result, the leakage of air from the tube can be retarded without any sealant.

According to the fifth aspect of the present invention, when the tube containing tire is pierced with a nail or the like in the radial direction or the transverse direction, the damaged portion of the tire is repaired by the contractible elasticity of the tire itself, and air within the air chamber is prevented from leaking to the rim side through a gap between the tube and the tire because the right and left side walls of the tube are adhesively bonded to the inner surface of the tire. In this case, any liquid sealant is not required.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a transverse sectional view of a wheel mounted with a tire containing a tube as a first embodiment of the present invention;

FIG. 2 is a transverse sectional view, similar to FIG. 1, showing a second embodiment of the present invention;

FIG. 3 is a transverse sectional view taken along line 3-3 of FIG. 8 showing a third embodiment of the present invention;

FIG. 4 is a transverse sectional view, similar to FIG. 1, showing a fourth embodiment of the present invention;

FIG. 5 is a transverse sectional view, similar to FIG. 1, showing a fifth embodiment of the present invention;

FIG. 6 is a transverse sectional view illustrating the procedure for mounting the tire as the fifth embodiment; and

FIG. 7 is a transverse sectional view, similar to FIG. 1, showing a sixth embodiment of the present invention, and FIG. 8 is a sectional view taken along line 8-8 of FIG. 3; and

FIG. 9 is a sectional view taken along line 9-9 of FIG. 8.

### DETAILED DESCRIPTION OF THE PREFERRED EMBODIMENTS

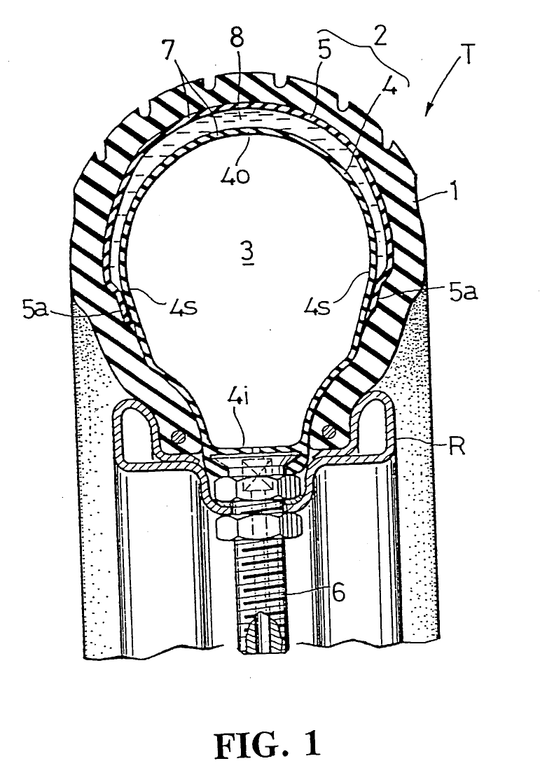

A first embodiment of the present invention will be described with reference to FIG. 1. A rim R of a wheel used for a motorcycle is connected to a hub (not shown) through wire spokes. A tire containing a tube, generally referred to as T, includes a tire 1 and a tube 2 contained in the tire 1 which are mounted on the rim R. The tube 2 includes a tube main body 4 and an annular band 5 formed in a U-shape in section. The tube main body 5 has inner and outer peripheral walls 4i, 4o and right and left side walls 4s, 4s, which are continuously connected to each other in such a manner as to internally form an annular air chamber 3. The annular band 5 is disposed so as to surround the tube main body 4 and is adhesively bonded at both side ends 5a, 5a to intermediate portions of both the side walls 4s, 4s of the tube main body 4. An air valve 6 is additionally provided in the inner peripheral wall 4i of the tube main body 4 for filling the air chamber 3 with air through the air valve 6. The annular band 5 is formed of the same material as that of the tube main body 4. The annular band 5 forms an enclosed bag like portion 7 in cooperation with the outer peripheral wall 4o and both the side walls 4s, 4s of the tube main body 4 facing to the annular band 5. The known liquid sealant 8 is sealed in the bag like portion 7.

In molding the bag like portion 7, the inner surface of the annular band 5, except for both the side ends 5a, 5a which are adhesively bonded to the tire 1, is coated with a mold releasing agent. The inner surface of the annular band 5 is brought into close contact with the tube main body 4, followed by vulcanization molding. The sealant 8 is injected into the flattened bag like portion 7 thus obtained by using a syringe or the like. At this time, the bag like portion 7 is suitably inflated with the sealant 8.

The function of this embodiment will be described below. The bag like portion 7 of the tube 2 constitutes the right and left side walls and the outer peripheral wall of the tube 2, and is held in a shape corresponding to that of the inner surface of the tire 1 by the effect of air pressure within the air chamber 3. The sealant 8 is sealed in the bag like portion 7, and thereby it is prevented from being shifted on the outer peripheral side of the tube 2 by a centrifugal force during rotation of the wheel. As a result, even when the tube 2, that is, the bag like portion 7 is pierced with a nail or the like in the radial direction or the transverse direction, the sealant 8 acts as an emergency repair by covering the damaged portion, retarding the leakage of air from the air chamber 3.

The sealant 8 is held in the bag like portion 7 and never leaks to the air chamber 3 side. Thereby, the sealant 8 does not block the air valve 6, the pressure gauge attached on the air valve 6, and the like.

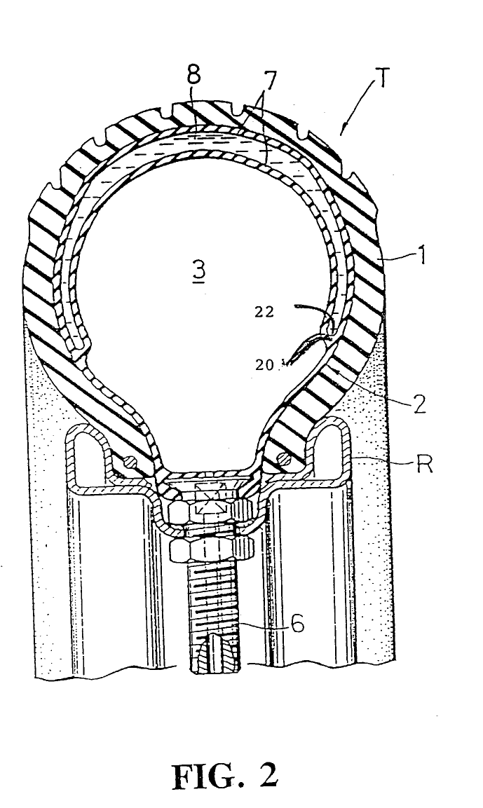

FIG. 2 shows a second embodiment of the present invention. This embodiment has the same configuration as that of the first embodiment, except that a tube 2 is molded integrally with a bag like portion 7. In FIG. 2, parts corresponding to those in the first embodiment are indicated by the same characters.

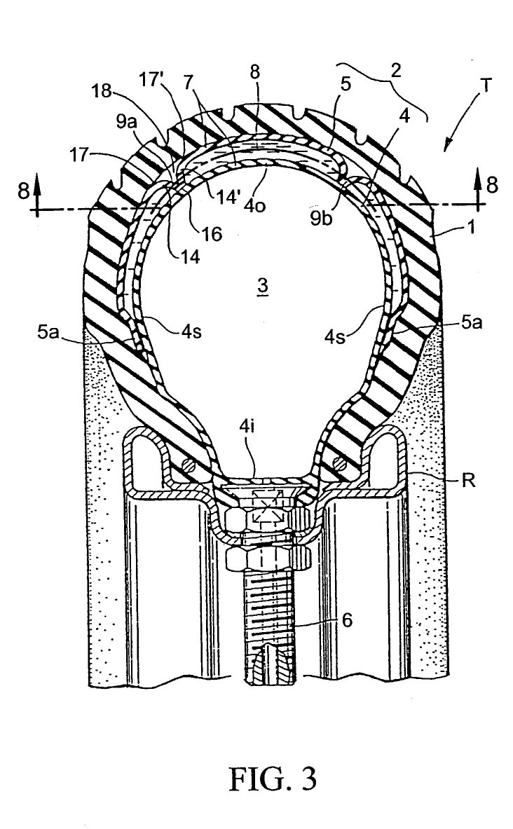

FIG. 3 shows a third embodiment of the present invention. This embodiment has the same configuration as that of the first embodiment, except that a plurality of discrete projections such as the discrete projections 9a and 9b projecting from one of the facing surfaces of an annular band 5 and a tube main body 4 are adhesively bonded on the other facing surface. In FIG. 3, parts corresponding to those in the first embodiment are indicated by the same characters.

In this embodiment, the thickness of the bag like portion 7 can be suitably specified by the presence of the plurality of the discrete projections such as the discrete projections 9a and 9b.

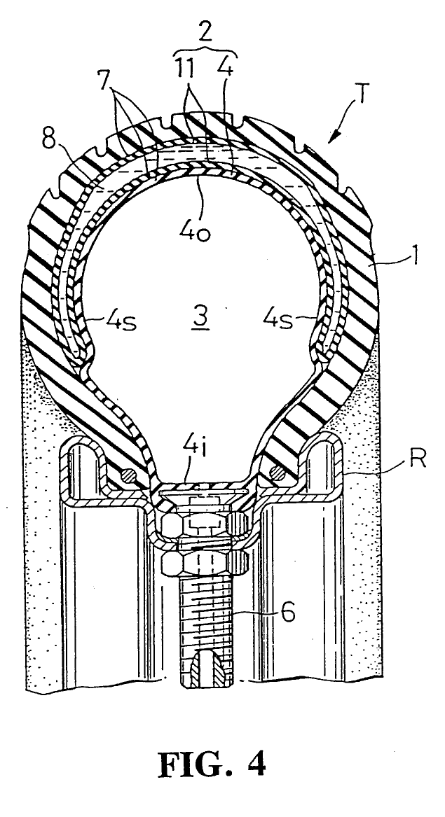

FIG. 4 shows a fourth embodiment of the present invention. In this embodiment, a tube 2 includes a tube main body 4 internally forming an annular air chamber 3, and an annular bag body 11. The annular bag body 11 is disposed so as to surround the tube main body 4 and is adhesively bonded on the outer surfaces of an outer peripheral wall 4o and right and left side walls 4s, 4s of the tube main body 4 over the entire circumference thereof. The annular bag body 11 is independently molded in an enclosed shape using the same material as that of the tube main body 4. An enclosed bag like portion 7 is composed of the annular bag body 11 and the outer peripheral wall 4a and the right and left side walls 4s, 4s adhesively bonded on the annular bag body 11. In this case, the inner peripheral wall of the bag like portion 7 is of a double wall structure having the tube main body 4 and the annular bag body 11 adhesively bonded to each other. The liquid sealant 8 is injected into the annular bag body 11.

The other configuration in this embodiment is the same as that of the first embodiment. In FIG. 4, parts corresponding to those in the first embodiment are indicated by the same characters.

In this embodiment, the annular bag body 11 is previously molded in an enclosed shape separately from the tube main body 4, and accordingly, the bag like portion 7 with a high air tightness can be easily obtained only by adhesively bonding the annular bag body 11 on the outer surface of the tube main body 4.

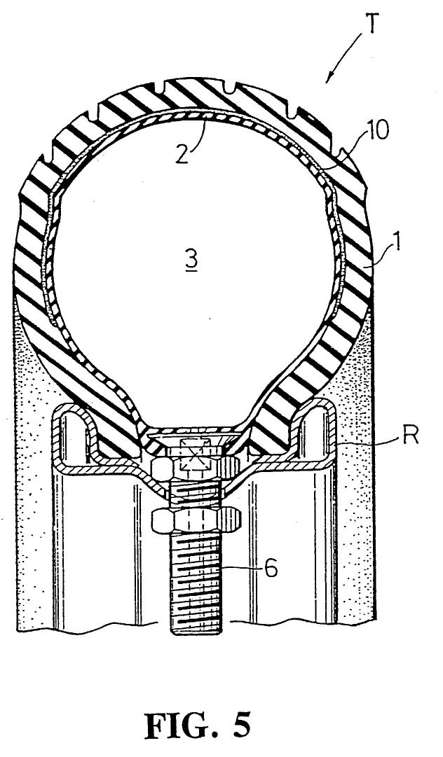

FIG. 5 shows a fifth embodiment of the present invention. A general tube 2 is adhesively bonded on the inner surface of a tire 1 in a range extending from right and left side walls to an outer peripheral wall of the tube 2 by an adhesive 10. In FIG. 5, parts corresponding to those in the first embodiment are indicated by the same characters.

In this embodiment, when the tire 1 and the tube 2 are pierced with a nail or the like in the radial or the transverse direction, the tire 1 is self repaired by its strong contractible elasticity but the tube 2 is poor in such a self repairing function. However, since the surroundings of the damaged portion of the tube 2 are adhesively bonded on the inner surface of the tire 1, air in the tube 2, that is, in the air chamber 3 is not diffused to the surroundings even when it passes through the damaged portion of the tube 2. As a result, the leakage of air from the air chamber 3 can be retarded without any sealant.

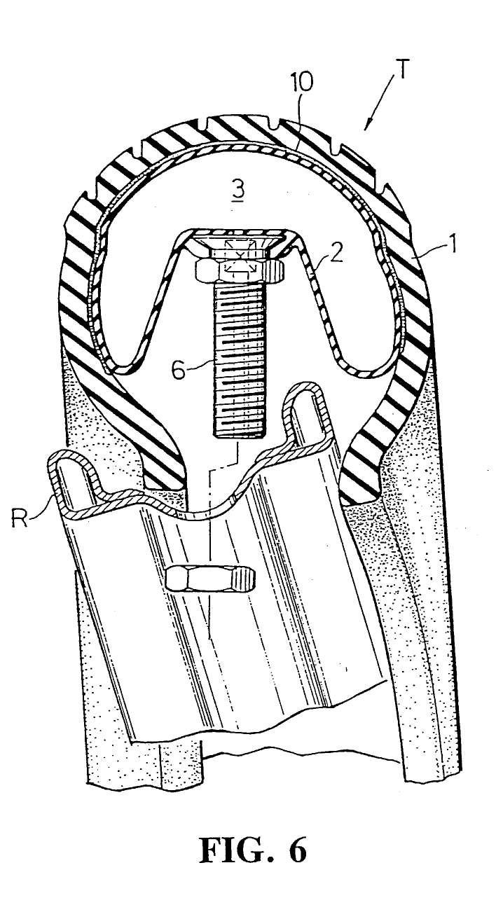

In this embodiment, the inner peripheral wall side of the tube 2 is not adhesively bonded on the tire 1, so that the mounting of the tire 1 on a rim R can be easily performed only by largely escaping the inner peripheral wall side of the tube 2 from the rim R, as shown in FIG. 6.

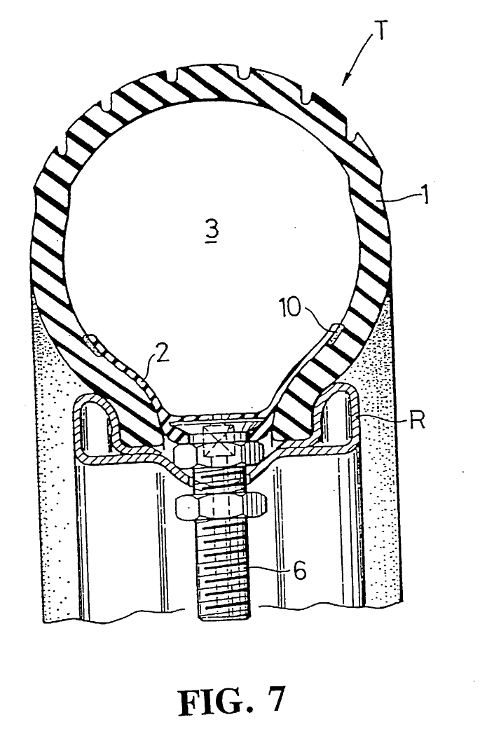

FIG. 7 shows a sixth embodiment of the present invention. This embodiment has the same configuration as that of the fifth embodiment, except that a tube 2 is formed in a U-shape in section (the outer peripheral side, being opened), and right and left side walls of the tube 2 are adhesively bonded on the inner surface of a tire 1 by adhesive 10, so that an air chamber 3 filled with air is formed between the tire 1 and the tube 2. In FIG. 7, parts corresponding to those in the fifth embodiment are indicated by the same characters.

Even in this embodiment, like the fifth embodiment, even when the tire 1 and the tube 2 are pierced with a nail or the like, the leakage of air from the air chamber 3 can be retarded.

In each of the above-described embodiments, various changes in design are possible without departing from the scope of the present invention. For example, in the embodiments shown in FIGS. 1 to 4, only the outer peripheral wall of the tube 2 may be composed of the bag like portion 7. Furthermore, in the embodiments shown in FIGS. 5 and 7, the bonding of the tire 1 to the tube 2 may be performed by vulcanization bonding.

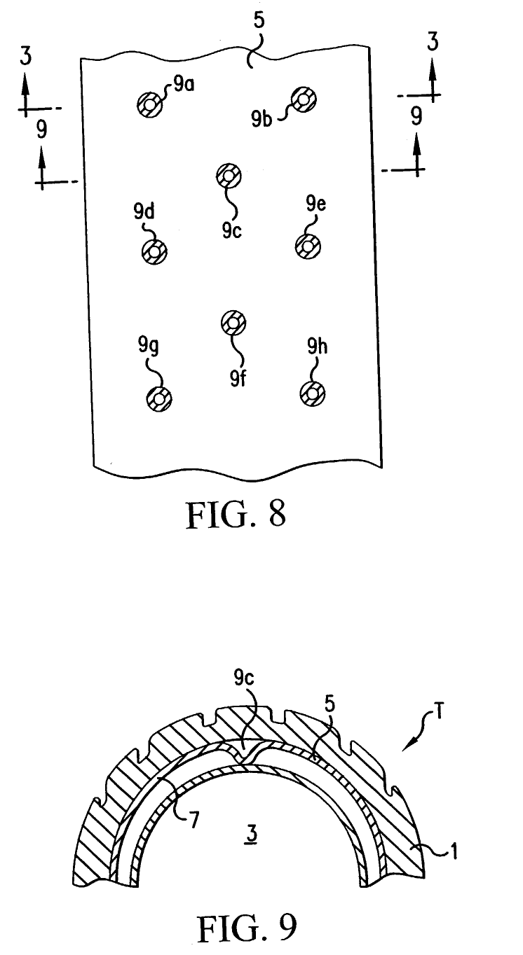

Referring now to FIGS. 8 and 9, the particular structure of that embodiment of FIG. 3 can be better seen. As shown in FIG. 8 there are a plurality of discrete projections namely the discrete projections 9a, 9b, 9c, 9d, 9e, 9f, 9g, and 9h together with other similar discrete projections (not shown) encircling the tube T. Each discrete projection including the discrete projections 9a, 9b, 9c, 9d, 9e, 9f, 9g, and 9h is formed in the annular band 5 and is bonded to the tube main body 4 at a point such as the point at numeral 16 in FIG. 3.

The discrete projections 9a, 9b, 9c, 9d, 9e, 9f, 9g, and 9h are in alternate rows. Discrete projections 9a and 9b define the first row. Projection 9c alone defines the second row. Discrete projections 9d and 9e define the third row. Projection 9f alone defines the fourth row. Discrete projections 9g and 9h define the fifth row. It will be understood that additional projection (not shown) define additional rows (not shown) all the way around the circumference of the band 5.

The first row has two discrete projections namely discrete projections 9a and 9b. The third row has two discrete projections namely discrete projections 9d and 9e. Thus it can be seen that there are two discrete projections in each odd numbered row.

The second row has a single projection namely the projection 9c. The fourth row has a single projection namely the projection 9f. Thus it can be seen that a single discrete projection is in the center of each even numbered row. In other words the rows of discrete projections are arranged evenly around the tube in a polka-dot pattern.

According to the first aspect of the present invention, at least the outer peripheral wall of the tube is composed of the bag like portion in which a liquid sealant is sealed. Even when the tube is pierced with a nail or the like through a tread portion of the tire, the sealant acts for emergency repair by covering the damaged portion. The sealant is also held in the bag like portion, and thereby it does not block an air valve or a pressure gauge of the tube at all.

According to the second aspect of the present invention, the right and left side walls and the outer peripheral wall of the tube are composed of the bag like portion in which a liquid sealant is sealed and are held in a shape corresponding to that of the inner surface of the tire by the effect of air pressure in the tube. As a result, the sealant is prevented from being locally shifted by a centrifugal force. Even when the tube is pierced with a nail or the like in the radial direction or in the transverse direction, the sealant acts for emergency repair by covering the damaged portion of the tube. Like the first aspect, the sealant sealed in the bag like portion does not block an air valve or a pressure gauge of the tube at all.

According to the third aspect of the present invention, the bag like portion is excellent in high air tightness and can be easily formed only by adhesively bonding the annular bag body on the outer surface of the tube main body.

According to the fourth aspect of the present invention, when the outer peripheral wall of the tube is pierced with a nail or the like through a tread portion of the tire, the damaged portion of the tire is repaired by contractible elasticity of the tire itself, and air leaking from the damaged portion of the tube is prevented from being diffused to the surroundings from the contact surface between the tire and the tube. As a result, the leakage of air from the tube can be retarded without any sealant.

According to the fifth aspect of the present invention, when the tire containing a tube is pierced with a nail or the like in the radial direction or the transverse direction, the damaged portion of the tire is repaired by the contractible elasticity of the tire itself, and air within an air chamber is prevented from leaking to the rim side through a gap between the tube and the tire because the right and left side walls of the tube are adhesively bonded to the inner surface of the tire. In this case, no liquid sealant is required.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A tire containing a tube comprising:
a tire;
a tube positioned within said tire, said tube comprising a tube main body forming an annular air chamber, and an annular band mounted on an outer surface of said tube main body to thereby form an enclosed bag portion on at least an outer peripheral wall of said tube main body, said enclosed bag portion comprising an annular sealant chamber which extends continuously around an entire circumference of said tube main body;
a liquid sealant being sealed in said enclosed bag portion; and
a plurality of projections formed on and extending continuously in an annular form along at least one of an inner surface of said annular band and said outer surface of said tube main body, said plurality of projections interconnecting said annular band with said tube main body for spacing said annular band a predetermined distance from said tube main body.

2. A tire containing a tube comprising:
a tire;
a tube positioned within said tire, said tube comprising a tube main body forming an annular air chamber, and an annular band mounted on an outer surface of said tube main body to thereby form an enclosed bag portion on right and left side walls and an outer peripheral wall of said tube main body, said enclosed bag portion comprising an annular sealant chamber which extends continuously around an entire circumference of said tube main body;
a liquid sealant being sealed in said enclosed bag portion; and
a plurality of projections formed on and extending continuously in an annular form along at least one of an inner surface of said annular band and said outer surface of said tube main body, said plurality of projections interconnecting said annular band with said tube main body for spacing said annular band a predetermined distance from said tube main body.

3. The tire containing a tube according to claim 1, wherein said annular band is adhesively bonded on said outer surface of said tube main body.

4. The tire containing a tube according to claim 2, wherein said annular band is adhesively bonded on said outer surface of said tube main body.

5. A tire containing a tube for providing an emergency repair of the tire comprising:
a tire having an outer surface and an inner surface;
a tube comprising a tube main body forming an annular air chamber, and an annular band mounted on an outer surface of said tube main body to thereby form an enclosed bag portion on an outer peripheral wall of said tube main body, said enclosed bag portion being positioned in a space formed between said tube main body and said inner surface of said tire, said enclosed bag portion comprising an annular sealant chamber which extends continuously around an entire circumference of said tube main body;
a valve in communication with said annular air chamber of said tube main body;
a plurality of projections formed on and extending continuously in an annular form along at least one of an inner surface of said annular band and said outer surface of said tube main body, said plurality of projections interconnecting said annular band with said tube main body for spacing said annular band a predetermined distance from said tube main body;
wherein said plurality of projections are formed on said inner surface of said annular band;
wherein at each of said plurality of projections, said annular band comprises a pair of oppositely curved arcuate portions each extending between a first point where said annular band is in contact with said tube main body, and spaced-apart second projections where the annular band comes into contact with said tire; and
a sealant being disposed within said enclosed bag portion for sealing a leak formed in said tire while said tube main body prevents sealant from entering said annular air chamber and blocking said valve.

6. The tire containing a tube for providing an emergency repair of the tire according to claim 5, wherein a portion of an inner surface of said annular band is coated with a mold releasing agent.

7. The tire containing a tube for providing an emergency repair of the tire according to claim 5, wherein said inner surface of said annular band is positioned in contact with said outer surface of said tube main body and is secured thereto by vulcanization molding.

8. The tire containing a tube for providing an emergency repair of the tire according to claim 5, wherein said annular band is integrally formed on said outer surface of said tube main body.

9. The tire containing a tube for providing an emergency repair of the tire according to claim 8, wherein said annular band is molded integrally with said tube main body.

10. The tire containing a tube for providing an emergency repair of the tire according to claim 5, wherein said annular band is adhesively secured to said outer surface of said tube main body.

11. The tire containing a tube for providing an emergency repair of the tire according to claim 10, wherein said annular band is adhesively secured to side wall portions of said tube main body.

12. The tire containing a tube according to claim 1, wherein said plurality of projections are formed on said inner surface of said annular band.

13. The tire containing a tube according to claim 2, wherein said plurality of projections are formed on said inner surface of said annular band.

14. The tire containing a tube according to claim 12, wherein said plurality of projections are adhesively bonded to said outer surface of said tube main body.

15. The tire containing a tube according to claim 13, wherein said plurality of projections are adhesively bonded to said outer surface of said tube main body.

16. The tire containing a tube for providing an emergency repair of the tire according to claim 1, wherein said plurality of projections are adhesively bonded to said outer surface of said tube main body.

17. A tire containing a tube comprising:
a tire;
a tube positioned within said tire, said tube comprising a tube main body forming an annular air chamber, and an annular band mounted on an outer surface of said tube main body to thereby form an enclosed bag portion on at least an outer peripheral wall of said tube main body, said enclosed bag portion comprising an annular sealant chamber which extends continuously around an entire circumference of said tube main body;
a liquid sealant being sealed in said enclosed bag portion; and
at least one discrete projection formed by a portion of said annular band and extending continuously annularly along an outer surface of said tube main body, said at least one discrete projection interconnecting said annular band with said tube main body for spacing said annular band a predetermined distance from said tube main body.

18. The tire containing a tube according to claim 1, further comprising an annular gap chamber formed between an outer surface of said annular band and an inner surface of said tire at a location of at least one of said projections, said annular gap chamber being free of sealant.

19. The tire containing a tube according to claim 12, further comprising an annular gap chamber formed between an outer surface of said annular band and an inner surface of said tire at a location of at least one of said projections, said annular gap chamber being free of sealant.

20. The tire containing a tube according to claim 13, further comprising an annular gap chamber formed between an outer surface of said annular band and an inner surface of said tire at a location of at least one of said projections, said annular gap chamber being free of sealant.

21. The tire containing a tube according to claim 17, further comprising an annular gap chamber formed between an outer surface of said annular band and an inner surface of said tire at a location of said at least one projection, said annular gap chamber being free of sealant.

22. The tire containing a tube according to claim 12, wherein at each of said plurality of projections, said annular band comprises a pair of oppositely curved arcuate portions each extending between a first point where said annular band is in contact with said tube main body, and spaced-apart second points where the annular band comes into contact with said tire.

23. The tire containing a tube according to claim 13, wherein at each of said plurality of projections, said annular band comprises a pair of oppositely curved arcuate portions each extending between a first point where said annular band is in contact with said tube main body, and spaced-apart second points where the annular band comes into contact with said tire.

24. The tire containing a tube according to claim 17, wherein at said at least one projection, said annular band comprises a pair of oppositely curved arcuate portions each extending between a first point where said annular band is in contact with said tube main body, and spaced-apart second points where the annular band comes into contact with said tire.

25. The tire containing a tube according to claim 5, wherein each discrete projection is formed in the band and is bonded to the tube at a point.

26. A tire containing a tube for providing an emergency repair of the tire comprising:
a tire having an outer surface and an inner surface;
a tube comprising a tube main body forming an annular air chamber, and an annular band mounted on an outer surface of said tube main body to thereby form an enclosed bag portion on an outer peripheral wall of said tube main body, said enclosed bag portion being positioned in a space formed between said tube main body and said inner surface of said tire, said enclosed bag portion comprising an annular sealant chamber which extends continuously around an entire circumference of said tube main body;
a valve in communication with said annular air chamber of said tube main body;
a plurality of discrete projections formed as an integral part of the annular band, wherein said plurality of discrete projections interconnecting said annular band with said tube main body for spacing said annular band a predetermined distance from said tube main body;
wherein said plurality of discrete projections are formed on said inner surface of said annular band;
wherein at each of said plurality of discrete projections, said annular band comprises a pair of oppositely curved arcuate portions each extending between a first point where said annular band is in contact with said tube main body, and spaced-apart second discrete projections where the annular band comes into contact with said tire; and
a sealant being disposed within said enclosed bag portion for sealing a leak formed in said tire while said tube main body prevents sealant from entering said annular air chamber and blocking said valve;
wherein each discrete projection is formed in the annular band and is bonded to the tube at a point; and
wherein the discrete projections are in alternate rows with a single discrete projection in the center of even numbered rows and two discrete projections spaced laterally apart in odd numbered rows; and
wherein the rows of discrete projections are spaced evenly around the tube in a polka-dot pattern.
